(19) United States
(12) Patent Application Publication
(10) Pub. No.: US 2026/0337043 A1
(43) Pub. Date: Oct. 29, 2026

(54) PREPARATION METHOD FOR MAGNESIUM OXIDE WITH HIGHLY EXPOSED {111} CRYSTAL PLANES AND USE THEREOF

(71) Applicant: Zhejiang University of Technology, Hangzhou (CN)

(72) Inventors: Chao HUO, Hangzhou (CN); Yize WANG, Hangzhou (CN)

(21) Appl. No.: 19/697,650

(22) Filed: Jun. 4, 2026

(30) Foreign Application Priority Data
Dec. 9, 2025 (CN) 202511846536.X

(51) Int. Cl. C01F 5/02; B01J 23/02; B01J 23/58; B01J 37/02; B01J 37/18; C01B 3/047

(52) U.S. Cl. CPC C01F 5/02; B01J 23/02; B01J 23/58; B01J 37/0201; B01J 37/18; C01B 3/047; C01P 2002/72; C01P 2002/74; C01P 2002/76; C01P 2004/03; C01P 2004/62; C01P 2004/64

(57) ABSTRACT

The present disclosure provides a preparation method for magnesium oxide with highly exposed {111} crystal planes and use thereof, the preparation method comprises the following steps: (1) uniformly mixing an aqueous solution of a surfactant with a mixed salt solution, and after a reaction, obtaining a precipitated suspension; wherein the mixed salt solution contains Mg²⁺, Zn²⁺, and Ba²⁺; and (2) allowing the precipitated suspension to stand for aging, then performing solid-liquid separation, drying, and calcination to obtain magnesium oxide with highly exposed {111} crystal planes. The magnesium oxide with highly exposed {111} crystal planes prepared by the present disclosure exhibits excellent catalytic performance, high activity, and strong stability when used as a catalyst support in ammonia decomposition for hydrogen production.

### TECHNICAL FIELD

The present disclosure relates to the cross-technology field of catalytic materials and energy conversion, particularly to a preparation method for magnesium oxide with highly exposed {111} crystal planes and use thereof.

### BACKGROUND

As a multifunctional inorganic material, magnesium oxide (MgO) is widely used in fields such as catalyst supports, gas adsorption, wastewater treatment and high-performance ceramics, owing to its suitable surface alkalinity, high thermal stability, excellent mechanical properties, and biocompatibility. The crystal plane structure is the core factor determining the surface properties of magnesium oxide. The {111} crystal plane is a highly active crystal plane in the cubic phase structure of magnesium oxide. The coordination number of the surface atoms on this plane is only 3 (which is much lower than the coordination number of 6 on the {100} crystal plane and 4 on the {110} crystal plane). Consequently, the {111} plane exhibits a high degree of atomic exposure and a large defect density. It can provide more active sites for catalytic reactions and, during adsorption, the binding energy to target molecules (such as NH₃ and heavy metal ions) is stronger. Therefore, achieving a high proportion of {111} crystal planes exposure is a key technical direction for improving the comprehensive application performance of magnesium oxide in many fields, including catalysis, adsorption, ceramics, flame retardancy, and medical carriers.

There are two core bottlenecks in the existing preparation methods for magnesium oxide:
1. Technical bottleneck: The conventional methods (such as the hydrothermal method, precipitation method, and sol-gel method) generally produce irregular particles or flake products. In these morphologies, the {111} crystal planes are easily encapsulated within the particles or covered by low-activity {100} and {110} crystal planes. The ratio of the {111} crystal plane diffraction peak intensity to the {200} crystal plane diffraction peak intensity is typically less than 0.8, resulting in a severe lack of exposure of the highly active {111} crystal planes. The core logic of the present disclosure is as follows: in order to achieve a high exposure of the {111} crystal plane, it is necessary to design a regular morphology directionally that maximizes the exposure of the {111} crystal plane. From the crystal structure of cubic MgO, it can be seen that the {111} crystal plane is the “inclined plane” of the cubic crystal (parallel to the plane formed by three adjacent vertices in the cube), and the regular octahedron is precisely a regular polyhedron composed of eight such {111} inclined planes. Each outer surface is a pure {111} crystal plane without interference from other crystal planes. Theoretically, the exposure rate of the {111} crystal plane can reach 100%, which is the only morphology capable of achieving “full surface exposure” of the {111} crystal plane. At present, the prior art has not yet achieved a method for this structure-crystal plane correlation. For example, patent CN111229213A uses magnesium carbonate as a magnesium source to prepare an MgO support via a hydrothermal method. The growth of MgO crystals is highly random, resulting in irregularly shaped particles and is dominated by low-activity {100} crystal planes. The ratio of the {111} crystal plane diffraction peak intensity to the {200} crystal plane diffraction peak intensity is only 0.7-0.8, indicating that the {111} crystal planes are encapsulated inside the particles, with an exposure rate of less than 30%.
2. Environmental protection and industrialization bottleneck: The conventional preparation processes generally suffer from a long reaction cycle (the hydrothermal method can take 8-24 h), high energy consumption, and particle agglomeration is prone to occur in the precipitation method. To address these issues, a large amount of dispersants or toxic etchants needs to be added, which leads to problems such as wastewater discharge and difficulties in industrial mass production. For example, the hydrothermal reaction cycle of patent CN111229213A is as long as 12-24 h, with high energy consumption (requiring the temperature to be maintained at 160-180 °C). Patent CN107892543A introduces sodium dodecylbenzene sulfonate (SDBS) as a dispersant to solve the particle agglomeration problem in the preparation of nano-magnesium oxide by the precipitation method. However, this solution introduces new industrialization and environmental risks: the high residual concentration of SDBS in the washing wastewater after the reaction causes the chemical oxygen demand (COD) value of the wastewater to soar. Meanwhile, to ensure the dispersion effect of SDBS, the pH and temperature of the system must be strictly controlled. Any fluctuation in these parameters leads to a chain reaction of “dispersion failure→particle agglomeration”, resulting in a batch repeatability deviation greater than 8%, making it difficult to adapt to parameter fluctuations in industrial continuous production.

The two bottlenecks result from poor structural controllability or low process efficiency, which restricts the industrial promotion and application of magnesium oxide materials. Therefore, developing a preparation method for magnesium oxide that meets the requirements of high efficiency, structural controllability, high {111} crystal plane exposure, and environmental protection has become the key to breaking through the existing technical bottlenecks and promoting its industrial application.

### SUMMARY

In view of the shortcomings of the above-mentioned existing technologies, an objective of the present disclosure is to provide a magnesium oxide with highly exposed {111} crystal planes, as well as a preparation method and use thereof. The core focus lies in “the inevitable correlation between the octahedral structure and high exposure of the {111} crystal plane.” By directionally regulating the growth of magnesium oxide into a regular octahedral shape, the problem of insufficient exposure of the {111} crystal plane is fundamentally solved from the perspective of morphology design. And the preparation process is optimized to meet industrial requirements and to expand its multi-field application scenarios.

To achieve the above and other related objectives, the present disclosure provides a preparation method for magnesium oxide with highly exposed {111} crystal planes, including the following steps:
(1) uniformly mixing an aqueous solution of a surfactant with a mixed salt solution, adjusting the pH of the system to 8.0-11.0, and after a reaction, obtaining a precipitated suspension; wherein the mixed salt solution contains Mg²⁺, Zn²⁺, and Ba²⁺;
(2) allowing the precipitated suspension to stand for aging, then performing solid-liquid separation, drying, and calcination to obtain magnesium oxide with highly exposed {111} crystal planes.

### Core Innovation Point

Innovation Point 1: Zn²⁺ induces the {111} crystal plane, and Ba²⁺ inhibits the “bidirectional coordinated crystal plane regulation” of the low active crystal planes, specifically:
Zn²⁺: inducer for directional growth of {111} crystal plane

The ionic radius of Zn²⁺ (0.074 nm) matches well with that of Mg²⁺ (0.072 nm), allowing Zn²⁺ to induce the growth of the {111} crystal plane via a mechanism of “lattice substitution-surface energy regulation.” Regarding rate control, Zn²⁺ can accelerate the atomic packing rate on the {111} crystal plane, thereby creating a competitive advantage of “{111} crystal plane dominates the growth.”
Ba²⁺: a potent inhibitor of low-activity crystal plane

Due to its large ionic radius (0.135 nm), Ba²⁺ cannot intercalate into the crystal lattice. Alternatively, it selectively adsorbs onto the active growth sites of the {100}/{110} crystal planes, forming a physical barrier that prevents further accumulation of Mg²⁺ on these planes. Through a mechanism of “surface adsorption-reconstruction inhibition”, the growth of low-activity crystal planes is blocked, ensuring that the inductive effect of Zn²⁺ remains undisturbed. Moreover, during calcination, Ba²⁺ forms —O—Ba— basic sites on the surface of MgO, which fix the atomic arrangement of the {111} crystal plane, thereby inhibiting crystal plane reconstruction and ensuring the stable existence of the {111} crystal planes on the regular octahedron.

Innovation Point 2: precise ratio control of cationic surfactant to magnesium carboxylate, specifically:

### Controllable Hydrolysis of Magnesium Carboxylate

Magnesium acetate, magnesium stearate, and other magnesium carboxylates are selected as the magnesium source. The carboxylate (—COO⁻) forms weak coordination bonds with Mg²⁺, thereby slowing down the hydrolysis rate of Mg²⁺ and preventing disordered grain growth caused by the sudden release of Mg²⁺. Meanwhile, the carboxylate is completely degraded after calcination, which does not affect the purity of the MgO crystal phase. This overcomes the drawback of inorganic magnesium salts, which lack weak coordination groups and undergo instantaneous hydrolysis under alkaline conditions, easily leading to the formation of agglomerates with non-uniform particle sizes. Furthermore, it is challenging to completely remove anions such as chloride, nitrate, and sulfate from inorganic magnesium salts, even after multiple washing steps After calcination, these inorganic salts are easily inserted into the MgO crystal lattice as impurity ions, resulting in lattice contamination.

### Template Effect of Cationic Surfactants

Cationic surfactants such as cetyltrimethylammonium bromide (CTAB) and dodecyl tri-methyl ammonium chloride (DTAC) are selected. The hydrophobic chain (e.g., the long chain of CTAB) adsorbs onto the surface of Mg(OH)₂ primary particles, while the hydrophilic head reacts with water molecules to form a regular octahedral growth template. This ensures that each grain grows toward the {111} crystal plane direction.

Under the action of ultrasonic precipitation during the preparation process, the raw materials are uniformly dispersed, thereby avoiding particle agglomeration and providing a stable environment for the uniform growth of the {111} crystal planes.

In some embodiments, in step (1), in the mixed salt solution, a molar ratio of Zn²⁺ to Mg²⁺ is (0.01-0.1):1; a molar ratio of Ba²⁺ to Mg²⁺ is (0.2-0.4):1; based on the mass of magnesium oxide, a mass fraction of zinc is 0.5-1.5%, and a mass fraction of barium is 4.0-6.0%.

In some embodiments, in step (1), Mg²⁺ is introduced to the mixed salt solution in the form of an organic magnesium salt; Zn²⁺ is introduced to the mixed salt solution in the form of a zinc salt; Ba²⁺ is introduced to the mixed salt solution in the form of a barium salt.

In some embodiments, in step (1), the surfactant is a cationic surfactant.

The cationic surfactants are preferred for the present disclosure because their hydrophobic chains can adsorb onto the surface of Mg(OH)₂ primary particles, and their hydrophilic heads interact with water molecules to inhibit disordered particle growth through a “template effect”.

In some more preferred embodiments, the organic magnesium salt contains the carboxylate, and a molar ratio of the carboxylate to the surfactant is (300-500):1. Compared with other organic magnesium sources and inorganic magnesium sources, the carboxylate-based magnesium source exhibits a mild hydrolysis rate during ultrasonic precipitation, slowly releasing Mg²⁺, thereby providing a stable ionic environment for the growth of regular octahedral crystals.

In some embodiments, in step (1), the organic magnesium salt is selected from at least one of magnesium acetate, magnesium stearate, magnesium citrate, and magnesium propylene glycol. The structural features and adaptation scenarios of each magnesium source are shown in Table 1. The zinc salt is zinc nitrate; and the barium salt is barium nitrate.

TABLE 1
Sources of organic magnesium

| Types of organic | | | |
|---|---|---|---|
| magnesium | | | Adaptation |
| sources | Structural Features | Substitution advantage | scenarios |
| Magnesium | Short-chain magnesium | Mild and controllable | General scenarios |
| acetate | carboxylate (C₂H₃OMg): | hydrolysis rate; slowly | requiring high |
| (Mg(CH₃COO)₂) | excellent water solubility; | releases Mg²⁺, avoiding | crystal plane |
| | neutral upon hydrolysis | excessive particle size | regularity and |
| | | or disordered growth | high batch stability |
| Magnesium | Long-chain fatty acid salt | Slowest hydrolysis | Scenarios |
| stearate | (C₁₈H₃₅O₂Mg): strong | rate; suitable for | requiring a |
| (MgSt₂) | hydrophobicity | regulating large-sized | support with low |
| | | (120-150 nm) regular | dispersity and |
| | | octahedron | high mechanical |
| | | | strength |
| Magnesium citrate | Magnesium | Strongly controllable | Supports with a |
| (Mg₃(C₆H₅O₇)₂) | hydroxycarboxylate: good | hydrolysis; readily | small particle size |
| | water solubility; weakly | forms hydrogen bonds | (60-90 nm) and a |
| | acidic upon hydrolysis | with cationic | high specific |
| | | surfactants | surface area |
| Magnesium | Magnesium alkoxide: | Excellent compatibility | Scenarios |
| propylene glycol | readily soluble in alcohol- | with ethanol solvent in | requiring a high |
| (Mg(C₃H₂O₂)₂) | water mixtures | impregnation | dispersion of the |
| | | processes; reduces | Ru active |
| | | phase separation | component |

In some embodiments, in step (1), the cationic surfactant is selected from at least one of cetyltrimethylammonium bromide, dodecyl tri-methyl ammonium chloride, octadecyltrimethylammonium chloride, and cetylpyridinium chloride. The types and characteristics of each of the above cationic surfactants are shown in Table 2:

TABLE 2
Cationic surfactants

| | | | Compatibility |
|---|---|---|---|
| | | | with Organic |
| | | | Magnesium |
| Cationic surfactants | Structural Type | Core Advantages | Source |
| Cetyltrimethylammonium | Long-chain | Precise templating | Compatible with |
| bromide(CTAB) | quaternary | effect; stably induces | magnesium |
| | ammonium salt | directional growth of | acetate (the |
| | (C₁₆) | {111} crystal planes. | optimal |
| | | Readily soluble at | combination of |
| | | room temperature, | the present |
| | | facilitating easy | disclosure) |
| | | process operation | |
| Dodecyl tri-methyl ammonium | Short-chain | Excellent water | Compatible with |
| chloride (DTAC) | quaternary | solubility; dissolves at | magnesium |
| | ammonium salt | low temperature (40- | stearate (long- |
| | (C₁₂) | 50 °C) with low energy | chain magnesium |
| | | consumption | source) |
| Octadecyltrimethylammonium | Long-chain | Strong templating | Compatible with |
| chloride (STAC) | quaternary | effect; readily induces | magnesium |
| | ammonium salt | large-sized (130-150 | propylene glycol |
| | (C₁₈) | nm) regular octahedron | (alcohol-soluble |
| | | | magnesium |
| | | | source) |
| Cetylpyridinium chloride | Heterocyclic | High surface charge | Compatible with |
| (CPC) | quaternary | density; strong ability | magnesium citrate |
| | ammonium salt | to inhibit particle | (acid- |
| | (containing a | agglomeration | hydrolyzable |
| | pyridine ring) | | magnesium |
| | | | source) |

In some embodiments, in step (1), an ultrasonic precipitation method is used for the preparation, and the pH of the reaction system is controlled to be 8.0-11.0 during the ultrasonic process, so as to ensure that Mg²⁺ is completely precipitated as Mg(OH)₂.

In some embodiments, in step (2), the precipitate suspension is dried at 60-120 °C for 8-36 h.

In some embodiments, in step (2), a calcination temperature is 400-550 °C and a calcination time is 3-4 h.

In some embodiments, the magnesium oxide with highly exposed {111} crystal planes has a micromorphology of a regular octahedral structure, with a particle size of 60-150 nm, and a ratio of the diffraction peak intensity of the {111} crystal plane to that of the {200} crystal plane in the cubic phase structure is greater than or equal to 1.2.

The present disclosure further provides a use for the above-described magnesium oxide with highly exposed {111} crystal planes in the field of catalyst supports, adsorbent materials, ceramic raw materials, flame retardant materials, or medical carriers.

The present disclosure further provides a use for the above-described magnesium oxide with highly exposed {111} crystal planes as a catalyst support for use in ammonia decomposition for hydrogen production, ammonia synthesis, CO oxidation, or hydrofinishing reactions.

The present disclosure further provides a preparation method for a supported functional material, the above-mentioned magnesium oxide with highly exposed {111} crystal planes is immersed in a solution of an active component, and after solid-liquid separation, is calcined in a reducing atmosphere to prepare the supported functional material.

In some embodiments, the solution of the active component is a ruthenium salt solution, and the solvent of the ruthenium salt solution is a ruthenium carbonyl (Ru₃(CO)₁₂) tetrahydrofuran solution. During the impregnation process, the ruthenium component is uniformly dispersed on the surface of the MgO support, and after reduction, nanoscale Ru particles are formed.

In some embodiments, a reducing atmosphere is H₂; and a calcination temperature is 400-450 °C.

When the reduction temperature is too low (<400 °C), the Ru atoms will not be sufficiently dispersed; when the reduction temperature is too high (>450 °C), Ru particles will agglomerate and sinter. The performance of the obtained catalyst is only improved when the reduction temperature is controlled within the above range.

In some embodiments, the magnesium oxide with highly exposed {111} crystal planes is immersed in the ruthenium salt solution, and after solid-liquid separation, is reduced by calcination at 400-450 °C in an H₂ atmosphere to produce the supported functional material.

In some embodiments, the magnesium oxide is used in the ammonolysis reaction, but is not limited to the listed applications:
(1) mixing the above-mentioned supported functional material with an equal volume of quartz sand, loading the mixture into a fixed bed reactor, and pretreating with H₂ at 380-420 °C for 1.5-2 h; introducing hydrogen gas and pretreating for 1.5-2 h under conditions of 380-420 °C and a hydrogen gas flow rate of 50-80 mL/min;
(2) the ammonia decomposition reaction is performed under conditions of a reaction temperature of 350-500 °C, a pressure of 0.1-0.5 MPa, and a high volumetric space velocity of ammonia gas; the conversion of ammonia is greater than or equal to 98%.

As described above, the present disclosure has the following advantageous effects:
(1) The process is highly efficient and environmentally friendly; the reaction time of ultrasonic precipitation is only 40-60 min, which is 40% shorter than that of the conventional hydrothermal method (8-24 h), and the energy consumption is reduced by 30%. There is no need to use a toxic etchant or a complex template; only deionized water is used in the washing process.
(2) The structure is highly controllable. By precisely controlling the ratios of acetate to cationic surfactant, zinc to magnesium, and barium to magnesium, the obtained regular octahedral MgO exhibits a morphology qualification rate of greater than or equal to 90% and a batch repeatability deviation is greater than or equal to 5%.
(3) The magnesium oxide with highly exposed {111} crystal planes prepared by the present disclosure exhibits excellent catalytic performance and high activity as a catalyst support for ammonia decomposition for hydrogen production. Under conditions of 450 °C and a high space velocity, the ammonia conversion rate is ≥98.5%, which is 9.4% higher than that of patent CN108160072A (90%). It also shows strong stability: the activity retention rate after 100 h of continuous reaction is ≥97%, much higher than that of conventional Ru/MgO catalysts (typically <90%). It also shows high selectivity: hydrogen selectivity is maintained at 100% at all times, with no by-products such as CO or CH₄.

### BRIEF DESCRIPTION OF THE DRAWINGS

FIG. 1 shows scanning electron microscope (SEM) images at different magnifications and a regular octahedron model diagram of a magnesium oxide-supported ruthenium catalyst prepared in Embodiment 1.

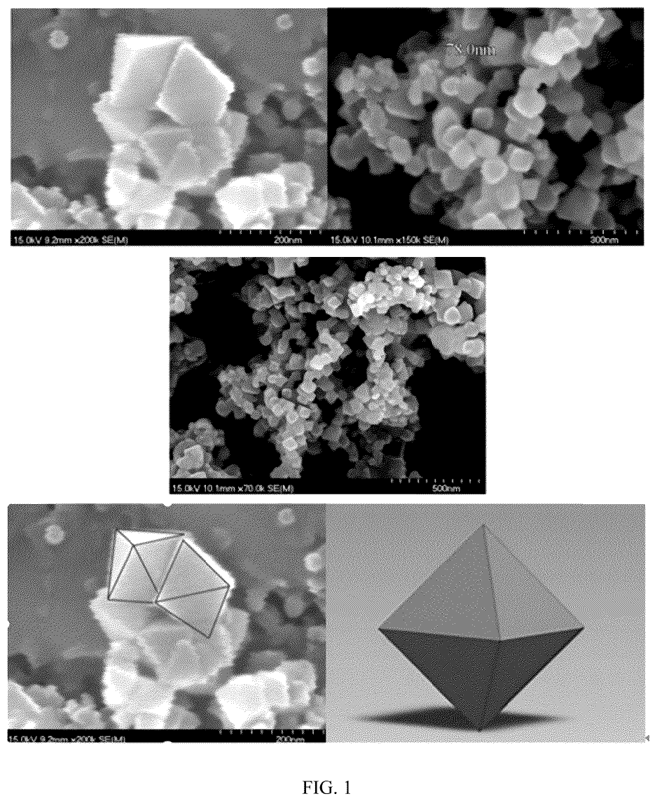

FIG. 2 shows an SEM image of a magnesium oxide-supported ruthenium catalyst prepared in Embodiment 2.

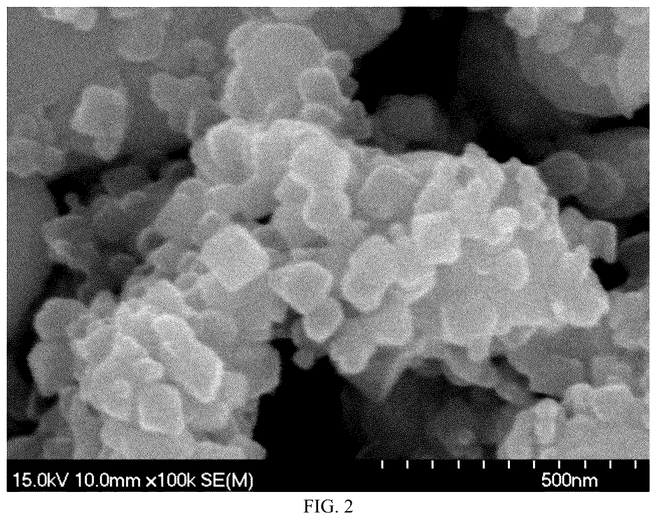

FIG. 3 shows an SEM image of magnesium oxide prepared in Embodiment 3.

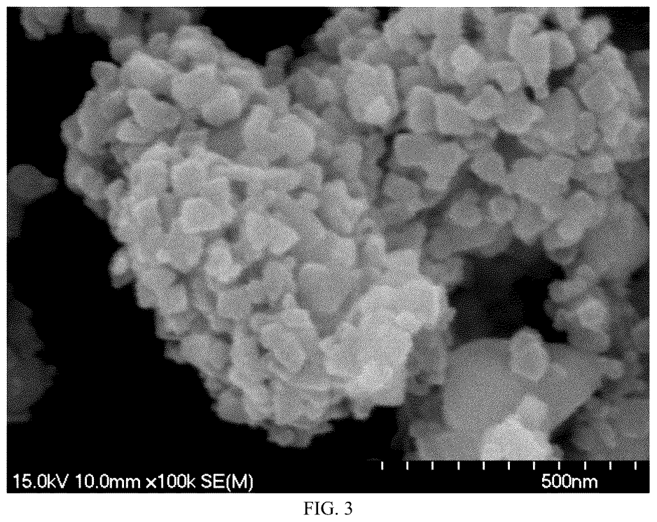

FIG. 4 shows an SEM image of magnesium oxide prepared in Embodiment 4.

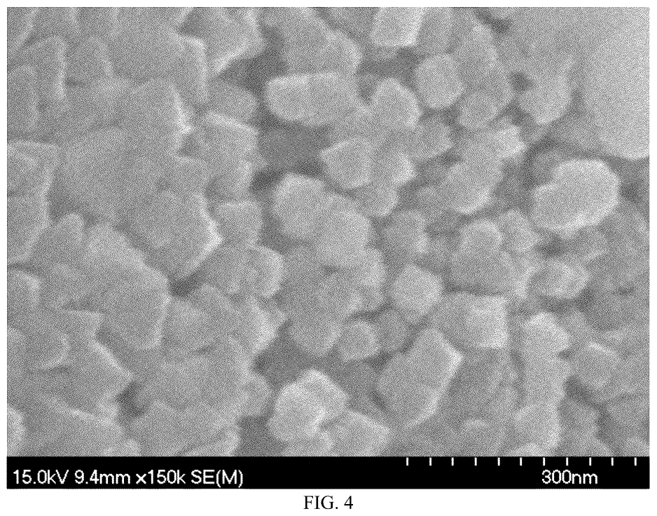

FIG. 5 shows an SEM image of magnesium oxide prepared in Embodiment 5.

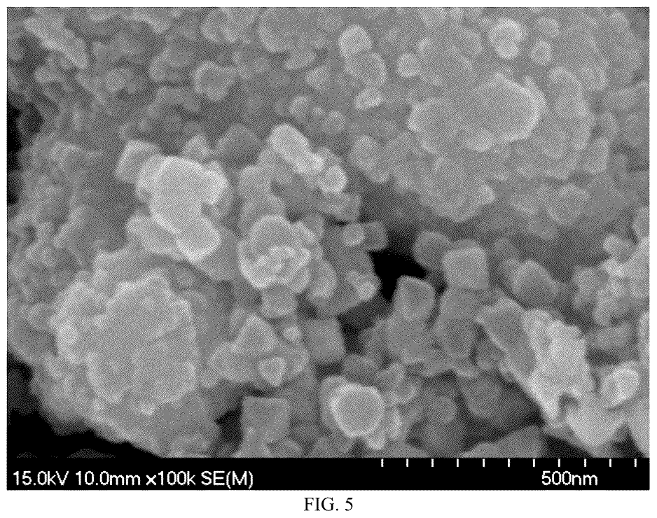

FIG. 6 shows an SEM image of magnesium oxide prepared in Embodiment 6.

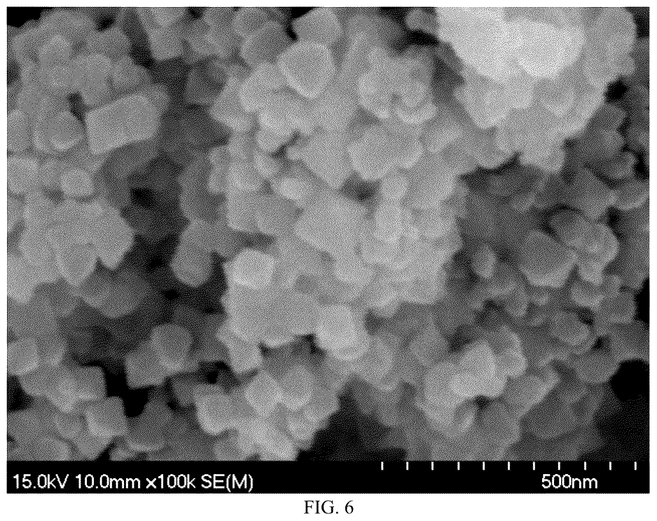

FIG. 7 shows an SEM image of magnesium oxide prepared in Embodiment 7.

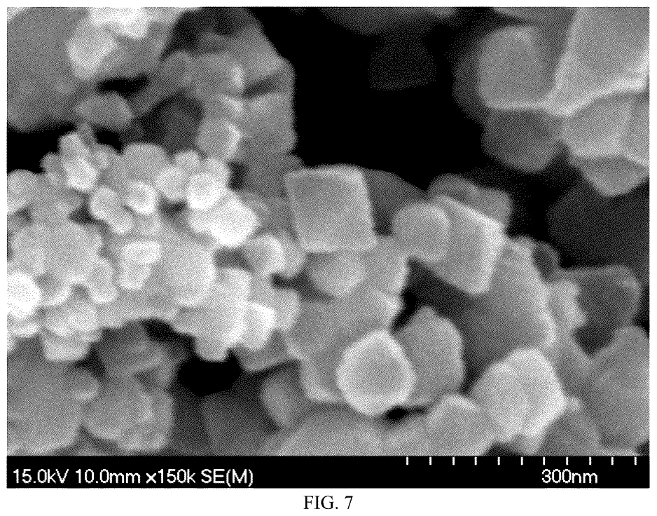

FIG. 8 shows an SEM image of magnesium oxide prepared in Comparative Embodiment 1.

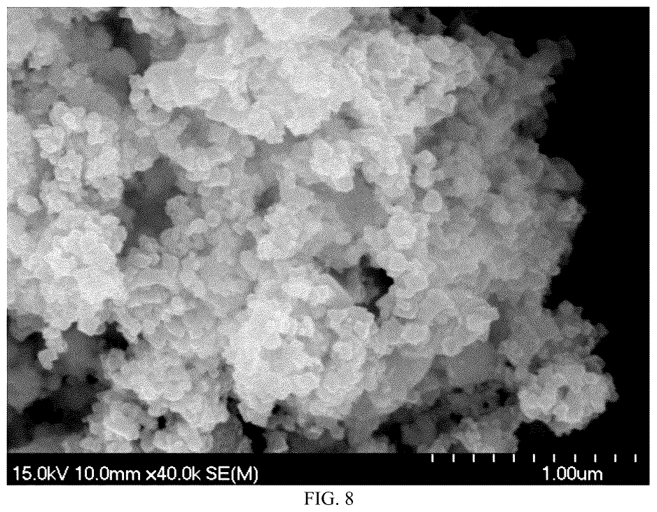

FIG. 9 shows an SEM image of magnesium oxide prepared in Comparative Embodiment 2.

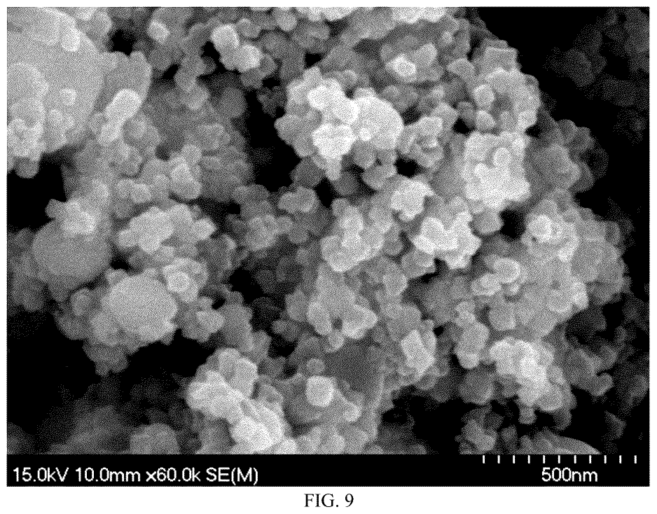

FIG. 10 shows an SEM image of magnesium oxide prepared in Comparative Embodiment 5.

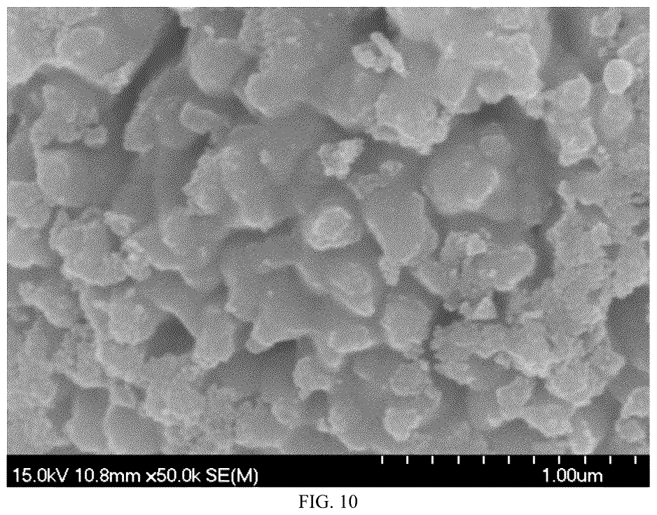

FIG. 11 shows an SEM image of magnesium oxide prepared in Comparative Embodiment 6.

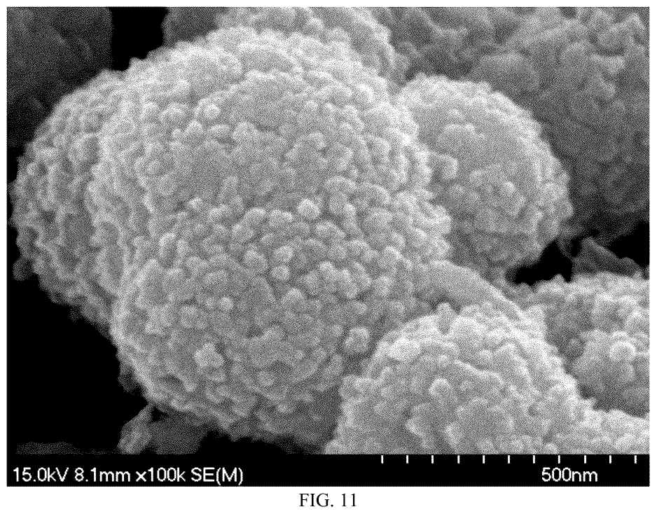

FIG. 12 shows X-ray diffraction (XRD) patterns of characteristic peaks before and after calcination of a magnesium oxide support doped with zinc and barium prepared in Embodiment 1, Comparative Embodiment 1, and Comparative Embodiment 2.

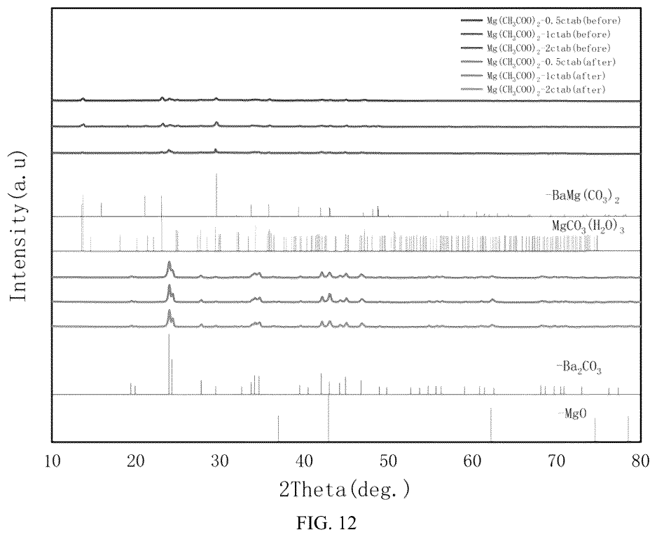

### DETAILED DESCRIPTION

The following describes embodiments of the present disclosure by reference to specific examples; however, those skilled in the art will readily understand other advantages and effects of the present disclosure from the disclosure herein. The present disclosure may also be implemented or applied through other embodiments, and the details described herein may be modified or altered in various ways based on different perspectives and applications, without departing from the spirit of the present disclosure.

It should be noted that any process equipment or apparatus not specifically described in the following embodiments shall be understood to be conventional equipment or apparatus within the art.

In this present disclosure, the specific steps for applying the catalyst prepared from magnesium oxide as a support in each of the following Embodiments and Comparative Embodiments to ammonia decomposition for hydrogen production are as follows:
(1) Catalyst pretreatment: the catalyst is crushed to 80-100 mesh, mixed with an equal volume of 80-100 mesh quartz sand, and loaded into the isothermal zone of the fixed bed reactor.
(2) Hydrogen (purity ≥99.999%) is introduced and pretreated for 1.5-2 h at 380-420 °C and a hydrogen flow rate of 50-80 mL/min.
(3) Ammonia decomposition reaction: the reaction is performed at a reaction temperature of 450 °C, a pressure of 0.1 MPa, and a high space velocity of ammonia gas.

### Embodiment 1

The embodiment provides a preparation method for magnesium oxide with highly exposed {111} crystal planes, including the following steps:
(1) Preparation of mixed salt solution: 0.1 mol of magnesium acetate (Mg(CH₃COO)₂: 4H₂O, 21.4 g), 0.003 mol of zinc nitrate (Zn(NO₃)₂·6H₂O, 0.89 g), and 0.02 mol of barium nitrate (Ba(NO₃)₂, 4.92 g) are weighed and added into 200 mL of deionized water, followed by stirring at room temperature for 25 min until they are completely dissolved.

Preparation of CTAB solution: 0.00025 mol of CTAB (C₁₉H₄₂BrN, 0.091 g) is weighed and added to 50 mL of deionized water, followed by stirring at 55 °C for 18 min until it is completely dissolved, and then cooled to room temperature.

Ultrasonic precipitation reaction: The CTAB solution is dropwise added into the mixed salt solution at a rate of 1 mL/min, with the stirring speed being 900 r/min. After the completion of dropwise addition, the pH is adjusted to 9.5 with concentrated aqueous ammonia solution, and the resulting mixture is transferred to an ultrasonicator (power 350 W, frequency 28 kHz) and ultrasonically reacted at 35 °C for 50 min to obtain a white precipitate suspension.
(2) The white precipitate suspension is allowed to stand for aging for 24 h, then filtered, vacuum dried at 90 °C (vacuum degree-0.085 MPa) for 14 h, thereafter placed in a muffle furnace, heated at 1 °C/min to 500 °C, and calcined for 3.5 h to obtain a regular octahedral MgO support doped with zinc and barium (particle size 75 nm, specific surface area 138 m²/g), namely, the magnesium oxide with highly exposed {111} crystal planes.

The present embodiment further provides a preparation method for a magnesium oxide-supported ruthenium catalyst, including:
Impregnation: 5 g of the regular octahedral MgO support is weighed and immersed in 25 mL of a ruthenium salt solution (0.03 mol/L Ru₃(CO)₁₂, the solvent being tetrahydrofuran), followed by stirring and immersing at 65 °C for 18 h.
Reduction: The sample is dried at 90 °C for 13 h, transferred to a tube furnace, introduced with hydrogen (flow rate 120 mL/min), heated at 4 °C/min to 400 °C, reduced for 2.8 h, and then cooled to obtain the regular octahedral magnesium oxide-supported ruthenium catalyst (Ru loading 1.2%).

### Embodiments 2-5

The difference between Embodiments 2-5 and Embodiment 1 is that the types of organic magnesium salts and cationic surfactants are different, as shown in Table 3, while the other processes are exactly the same.

TABLE 3
Performance results of raw materials and magnesium oxide-
supported ruthenium catalysts in Embodiments 1-5

| | | | | Catalytic |
|---|---|---|---|---|
| | | | | Performance |
| | Organic | | | (450 °C, high |
| | Magnesium | | Magnesium | space velocity |
| Group | Source | Cationic Surfactant | Oxide Support | of 20000 h⁻¹) |
| Embodiment 1 | Magnesium | Cetyltrimethylammonium | Morphology: | Ammonia |
| | acetate | bromide (CTAB) | regular | conversion: |
| | | | octahedron | 98.5-99.5%; |
| | | | (formation rate | 100 h |
| | | | ≥92%); particle | retention rate: |
| | | | size: 60-150 nm | 97.0-98.0% |
| Embodiment 2 | Magnesium | Cetyltrimethylammonium | Morphology: | Ammonia |
| | stearate | bromide (CTAB) | regular | conversion: |
| | | | octahedron | 93-94%; 100 h |
| | | | (formation rate | retention rate: |
| | | | 78-82%); | 91-92% |
| | | | relatively large | |
| | | | particles with | |
| | | | adhesion | |
| Embodiment 3 | Magnesium | dodecyl tri-methyl ammonium | Morphology: | Ammonia |
| | stearate | chloride (DTAC) | regular | conversion: |
| | | | octahedron | 96.5-97.5%; |
| | | | (formation rate | 100 h |
| | | | 76-82%); | retention rate: |
| | | | particle size: | 96.0-97.0% |
| | | | 120-145 nm | |
| Embodiment 4 | Magnesium | Cetylpyridinium chloride | Morphology: | Ammonia |
| | citrate | (CPC) | regular | conversion: |
| | | | octahedron | 98.0-99.0%; |
| | | | (formation rate | 100 h |
| | | | 85-90%); | retention rate: |
| | | | particle size: | 95.0-96.0% |
| | | | 65-95 nm | |
| Embodiment 5 | Magnesium | Octadecyltrimethylammonium | Morphology: | Ammonia |
| | propylene | chloride (STAC) | regular | conversion: |
| | glycol | | octahedron | 94.8-95.8%; |
| | | | (formation rate | 100 h |
| | | | 87-89%); | retention rate: |
| | | | particle size: | 96.5-97.5% |
| | | | 100-130 nm | |

From Table 3, it can be seen that the morphology control of the magnesium oxide-supported ruthenium catalyst prepared by the reaction system of Embodiment 1 is optimal: the regular octahedral qualification rate and regularity are the highest, and the final molding rate is ≥95%.

### Embodiments 6-7

The difference between Embodiments 6-7 and Embodiment 1 is that the ratio of acetate to CTAB is different, as shown in Table 4, while the other processes are exactly the same. Comparative Embodiments 1-2

The difference between Comparative Embodiments 1-2 and Embodiment 1 is that the ratio of acetate to CTAB is different, as shown in Table 4, while the other processes are exactly the same.

TABLE 4
Molar ratio of acetate ions to CTAB and performance
of the magnesium oxide-supported catalyst in Embodiments
1, 6-7 and Comparative Embodiments 1-2

| | Molar ratio | | | |
|---|---|---|---|---|
| | of acetate | Morphology of | Ammonia | 100 h |
| | ions to | magnesium | conversion at | retention |
| Group | CTAB | oxide support | 450 °C (%) | rate (%) |
| Embodiment 1 | 400:1 | Regular | 98.7 | 97.3 |
| | | octahedron | | |
| Embodiment 6 | 300:1 | Regular | 96.3 | 94.3 |
| | | octahedron | | |
| Embodiment 7 | 500:1 | Regular | 97.1 | 95.5 |
| | | octahedron | | |
| Comparative | 200:1 | Agglomerated | 91.2 | 90.5 |
| Embodiment 1 | | octahedron | | |
| Comparative | 800:1 | Defective | 93.5 | 92.1 |
| Embodiment 2 | | octahedron | | |
| | | (blurred edges | | |
| | | and corners) | | |

It can be seen from Table 4 that when the molar ratio of acetate to CTAB is in the range of 300-500, the regular octahedral magnesium oxide-supported ruthenium catalyst can be stably prepared, and the catalytic performance is optimal.

### Comparative Embodiment 3

The difference between Comparative Embodiment 3 and Embodiment 1 is that zinc nitrate is not added, as shown in Table 5, while the other processes are exactly the same.

### Comparative Embodiment 4

The difference between Comparative Embodiment 4 and Embodiment 1 is that barium nitrate is not added, as shown in Table 5, while the other processes are exactly the same.

### Comparative Embodiment 5

The difference between Comparative Embodiment 5 and Embodiment 1 is that zinc nitrate and barium nitrate are not added, as shown in Table 5, while the other processes are exactly the same.

### Comparative Embodiment 6

The difference between Comparative Embodiment 6 and Embodiment 1 is that CTAB is not added, as shown in Table 5, while the other processes are exactly the same.

TABLE 5
Reaction systems and catalytic performance of magnesium oxide-supported
ruthenium catalysts in Embodiment 1 and Comparative Embodiments 3-6

| | | | | Catalytic Performance |
|---|---|---|---|---|
| | | | Magnesium Oxide | (450 °C, space velocity |
| Group | Additives | Surfactant | Support | 20000 h⁻¹) |
| Embodiment 1 | Zinc | CTAB | Morphology: regular | Ammonia conversion: |
| | nitrate + | | octahedron (formation | 98.5-99.5%; 100 h |
| | barium | | rate ≥92%); particle | activity retention rate: |
| | nitrate | | size: 60-150 nm | 97.0-98.0% |
| Comparative | Barium | CTAB | Octahedron qualification | Ammonia conversion: |
| Embodiment 3 | nitrate | | rate: 75-80%; | 88-90%; 100 h retention |
| | | | octahedron-like | rate: 86-87% |
| | | | morphology, poor | |
| | | | crystal plane regularity | |
| Comparative | Zinc | CTAB | Octahedron qualification | Ammonia conversion: |
| Embodiment 4 | nitrate | | rate: 80-85%; some | 90-92%; 100 h retention |
| | | | particles with missing | rate: 89-90% |
| | | | edges/corners | |
| Comparative | None | CTAB | No octahedral | Ammonia conversion: |
| Embodiment 5 | (not | | morphology; irregular | 84-86%; 100 h retention |
| | added) | | agglomerated particles, | rate: 82-83% |
| | | | severe agglomeration | |
| Comparative | Zinc | No surfactant; | No octahedral | Ammonia conversion: |
| Embodiment 6 | nitrate + | process | morphology; irregular | 89-91%; 100 h retention |
| | barium | modified to the | blocky particles | rate: 88-89% |
| | nitrate | hydrothermal | | |
| | | method | | |

From Table 5, it can be seen that the cationic surfactant is the core template for the regular octahedral morphology by comparing Embodiment 1 and Comparative Embodiment 6: when no cationic surfactant is added in Comparative Embodiment 6, the primary particles of Mg(OH)₂ grow randomly, a regular crystal surface cannot be formed, and the process efficiency is extremely poor. By comparing Embodiment 1 with Comparative Embodiments 1-6, it can be seen that the presence of all key components is essential: an organic magnesium source, Zn—Ba dual additives, and a cationic surfactant are necessary conditions for the optimal system to achieve a regular octahedral morphology and high catalytic performance, and the absence of any component leads to a significant decline in performance.

The efficiency of the ultrasonic precipitation method (40-60 min) in Embodiment 1 is 15-20 times higher than that of the hydrothermal method (10-14 h) in Comparative Embodiment 6, and there is no need to adjust the solvent, pH, or temperature. The feasibility for mass production is much higher than that of various control schemes. In Embodiment 1, magnesium acetate has good water solubility (without a special mixed solvent), neutral hydrolysis (without pre-adjustment of pH), and CTAB is easy to dissolve at room temperature (without high-temperature heating). The process steps are 2-3 fewer than those in the modified systems (such as the ethanol-water solvent in Embodiment 3, pH adjustment in Embodiment 4, and STAC dissolution at high temperature in Embodiment 5), and the raw material cost is low and industrially available. In Comparative Embodiments 3-5, which lack additives, the crystal control environment of magnesium acetate and CTAB is destroyed, and the catalytic performance declines. It is proven that the catalyst prepared by the technical scheme with dual additives exhibits the optimal performance.

In summary, in the present disclosure, by precisely regulating the ratio of raw materials, combined with Zn—Ba dual additives and the ultrasonic precipitation method, regular octahedral magnesium oxide (any face of the cube being a highly exposed active {111} crystal plane) is successfully prepared. It shows excellent activity and stability in the hydrogen production reaction by ammonia decomposition, and has important industrial application value. Therefore, the present disclosure effectively overcomes various shortcomings in the existing technology and possesses high industrial utilization value.

It should be noted that the above embodiments are merely used for the purpose of describing the disclosed embodiments of the present disclosure and should not be understood as limiting the scope of the present disclosure. Furthermore, various modifications and variations in the methods and compositions of the present disclosure set out herein will be apparent to those skilled in the art, provided that they do not depart from the scope and spirit of the present disclosure. Although the present disclosure has been described in detail with reference to various specific and preferred embodiments, it should be understood that the present disclosure is not limited to these specific embodiments. Consequently, various modifications as described above, which are obvious to those skilled in the art for achieving the present disclosure, should be understood to fall within the scope of the present disclosure.

What is claimed is:

1. A preparation method for magnesium oxide with highly exposed {111} crystal planes, comprising the following steps:
(1) uniformly mixing an aqueous solution of a surfactant with a mixed salt solution, and after a reaction, obtaining a precipitated suspension; wherein the mixed salt solution contains Mg²⁺, Zn²⁺, and Ba²⁺; and
(2) allowing the precipitated suspension to stand for aging, then performing solid-liquid separation, drying, and calcination to obtain magnesium oxide with highly exposed {111} crystal planes.

2. The preparation method according to claim 1, wherein in step (1), in the mixed salt solution, a molar ratio of Zn²⁺ to Mg²⁺ is (0.01-0.1):1; a molar ratio of Ba²⁺ to Mg²⁺ is (0.2-0.4):1; based on a mass of magnesium oxide, a mass fraction of zinc is 0.5-1.5%, and a mass fraction of barium is 4.0-6.0%.

3. The preparation method according to claim 1, wherein in step (1), Mg²⁺ is introduced to the mixed salt solution in the form of an organic magnesium salt; Zn²⁺ is introduced to the mixed salt solution in the form of a zinc salt; Ba²⁺ is introduced to the mixed salt solution in the form of a barium salt; the surfactant is a cationic surfactant; and the organic magnesium salt contains the carboxylate, and a molar ratio of the carboxylate to the surfactant is (300-500):1.

4. The preparation method according to claim 1, wherein the organic magnesium salt is selected from at least one of magnesium acetate, magnesium stearate, magnesium citrate, and magnesium propylene glycol; the zinc salt is zinc nitrate; and the barium salt is barium nitrate.

5. The preparation method according to claim 3, wherein the cationic surfactant is selected from at least one of cetyltrimethylammonium bromide, dodecyl tri-methyl ammonium chloride, octadecyltrimethylammonium chloride, and cetylpyridinium chloride.

6. The preparation method according to claim 1, wherein in step (1), an ultrasonic precipitation method is used for the preparation, and pH of the reaction system is controlled to be 8.0-11.0 during the ultrasonic process.

7. The preparation method according to claim 1, wherein in step (2), the precipitate suspension is dried at 60-120 °C for 8-36 h; a calcination temperature is 400-550 °C, and a calcination time is 3-4 h.

8. A magnesium oxide with highly exposed {111} crystal planes prepared by the preparation method according to claim 1, the magnesium oxide with highly exposed {111} crystal planes has a micromorphology of a regular octahedral structure, with a particle size of 60-150 nm, and a ratio of a diffraction peak intensity of the {111} crystal plane to that of a {200} crystal plane in the cubic phase structure is greater than or equal to 1.2.

9. A use for the magnesium oxide with highly exposed {111} crystal planes according to claim 8, wherein the magnesium oxide is applied in the field of catalyst supports, adsorbent materials, ceramic raw materials, flame retardant materials, or medical carriers.

10. The use according to claim 9, wherein the magnesium oxide is used as a catalyst support in reactions such as ammonia decomposition for hydrogen production, ammonia synthesis, and CO oxidation.
